(19) United States
(12) Patent Application Publication
(10) Pub. No.: US 2016/0375760 A1
(43) Pub. Date: Dec. 29, 2016

(54) APPARATUS FOR RECEIVING, STORING, CARRYING AND DISCHARGING A LIQUID AS WELL AS AN OVERALL SYSTEM AND VEHICLE

(71) Applicant: SILICONE FIRE AG, Meggen (CH)

(72) Inventor: Peter Grauer, Meggen (CH)

(73) Assignee: SILICONE FIRE AG, Meggen (CH)

(21) Appl. No.: 15/260,267

(22) Filed: Sep. 8, 2016

Related U.S. Application Data
(63) Continuation-in-part of application No. 14/346,311, filed on Nov. 14, 2014, now abandoned.

(51) Int. Cl. B60K 15/04; B60K 6/46; B60L 11/12; F02B 63/04; F02M 37/00

(52) U.S. Cl. CPC B60K 15/04; F02B 63/04; F02M 37/0017; F02M 37/007; B60L 11/123; B60K 6/46; B60K 2015/03184

(57) ABSTRACT

An apparatus for receiving, storing, carrying and discharging a liquid, which comprises a container with a discharging device for discharging the liquid. The discharging device has a hollow cylindrical shape and is connected to the container. Another side has a discharge opening. There is a protective layer at the discharging device near the container, which holds back the liquid. The protective layer is set-back with respective to the discharge opening by a minimum distance.

### CROSS-REFERENCE TO RELATED APPLICATIONS

The present application is a continuation-in-part of U.S. patent application Ser. No. 14/346,311, filed on Nov. 14, 2014, which further claims the priority to European Patent Application No. EP 11182203.7, which was filed with the European Patent Office on Sep. 21, 2011, in the same name of the present applicant. These applications are incorporated by reference in their entirety for all purposes.

### BACKGROUND OF THE INVENTION

Petrol, in most cases, is sold via gasoline pumps at petrol stations. This is not only the case for fossil fuels but also for alternative fuels, such a bio-ethanol or hydrogen.

There are going to be more and more electric vehicles or hybrid vehicles which are either equipped with a fuel cell or which comprise a combustion engine as range extender in order to produce electric current on-board, which can be stored in a battery. To date, such a range extender is being supplied with fuel from a conventional tank in order to combust the fuel to drive an electric generator.

Most recent developments enable the production of methanol using carbon dioxide and hydrogen. Examples for this can be derived from the following patent applications:

International patent application with the publication number WO2010069622A1, which was filed with the European Patent Office on Aug. 13, 2009 with title “VERFAHREN AND ANLAGE ZUM BEREITSTELLEN EINES ENERGIETRAGERS UNTER EINSATZ VON CARBON DIOXIDE ALS KOHLENSTOFFLIEFERANT AND VON ELEKTRISCHER ENERGIE”. This international patent application concerns an intelligent mix of energies with an optimum economic and ecological combination of regenerative and conventional electric current supply in connection with the production of methanol.

International Patent application with the publication number WO2011018124A1, which was filed with the European Patent Office on Sep. 9, 2009 with title “Verfahren und Anlage zum Bereitstellen eines kohlenhydrogen-basierten Energietragers unter Einsatz eines Anteils von regenerativ erzeugtem Methanol und eines Anteils von Methanol, der mittels Direktoxidation oder uiber partielle Oxidation oder tiber Reformierung erzeugt wird”. This International patent application concerns the deployment of a portion of regeneratively produced methanol and a portion of methanol being produced by means of direct oxidation or via a partial oxidation or via a reforming process.

International patent application with application number PCT/EP2010/064948, which was filed with the European Patent Office on Oct. 6, 2010 with title “VERFAHREN AND ANLAGE ZUR SYNTHESE VON KOHLENHYDROGEN”. This international Patent application concerns a reactor which is particularly advantageous for the synthesis of methanol using a syngas comprising carbon dioxide (CO2) and hydrogen (H2).

International Patent application with application number PCT/EP2010/067812, which was filed with the European Patent Office on 10 Nov. 2010 with title “METHOD AND APPARATUS FOR THE INTEGRATION SYNTHESIS OF METHANOL IN A PLANT”. This international Patent application concerns a synthesis of methanol being integrated into an overall system. Coal or hydrocarbon is combusted together with oxygen in a furnace chamber. The oxygen is provided by a water-electrolysis. Carbon dioxide is washed out of the flue gas of this combustion process and is handed over to a reforming plant. The carbon dioxide together with the gaseous hydrocarbon is therein transformed into syngas comprising carbon monoxide and hydrogen. The syngas is then transformed to methanol in a reactor together with further hydrogen from the water-electrolysis.

European patent application with application number EP 11155310.3, which was filed with the European Patent Office on Feb. 22, 2011 with title “Verfahren zur Bereitstellung und zum Einsetzen eines Alkohols und Verwendung des Alkohols zur Wirkungsgrad-und Leistungssteigerung einer Verbrennungskraftmaschine”. This patent application concerns the usage of an alcohol (preferably a methanol-water mixture) for improving the efficiency and power of a combustion engine, such as a diesel engine.

The methods described in these documents are based on the use of carbon dioxide for producing methanol. This offers to possibility to recycle carbon dioxide by producing methanol. The correspondingly produced methanol can be regarded to be CO₂-neutral or at least partially CO₂-neutral, depending on the production method and energy supply.

Methanol is an alcohol which is particularly advantageous since it is the simplest alcohol that exists. In the future methanol will increasingly be used in connection with the mobility, in fact either to drive direct methanol fuel cells or to be transformed in combustion engines (such as range extenders).

For the applications mentioned before there is a demand for providing such fuels, combustibles or heating materials, such as methanol, in a form independent from petrol stations and independent from the existing infrastructure. The circumstances concerning mobility are going to see a considerable change in the next years. Thus, the installation of a distribution chain would be ideal which is based on sales points in different shops. For this, a container is needed which is able to safely store fuels, combustibles or heating materials. Furthermore, the handling of this container should be tamper-resistant and hazard-free.

### BRIEF SUMMARY OF THE INVENTION

It is an objective to provide a container which is able to receive, store, carry and discharge fuels, combustibles or heating materials.

In particular, the providing of an overall system with container and an optional (buffer-)tank, which enables a safe fueling of the tank (decanting) or the vehicle by the employment of the tank.

In accordance with the invention, an apparatus is provided for receiving, storing, carrying and discharging a liquid. The apparatus comprises a container with a discharging device for discharging the liquid. The discharging device preferably has a hollow cylinder shape and it is connected with the container in an area of a first side close to the container. It comprises a discharge opening in an area of a second side. In the area of the first side close to the container, a protective layer, or another mechanical protection, is provided being positioned with an offset of a minimum distance with respect to the discharge opening in order to prevent it from being destroyed or against unauthorized or unintended manipulation.

The present invention can not only be used in connection with vehicles, such as electric vehicles. It is also suitable for numerous other engine-powered equipment and apparatus, such as, for instance, gardening tools (lawn mower), kitchen and household devices, computers, ancillary units, ventilation systems, alarm systems, emergency systems and the like.

Due to the passive nature of the container, the discharging of the methanol fuel is carried out without electricity by means of gravitation-fueling. It is an advantage of this approach that no electric discharge or spark could potentially put the container on fire while being discharged.

Further advantageous embodiments can be derived from the specification, the figures and the dependent claims.

### BRIEF DESCRIPTION OF THE DRAWINGS

Different aspects of the invention are schematically depicted in the drawings:

FIG. 1 shows a diagrammatic plan which discloses the basics steps of a method for producing and using methanol;

FIG. 2 shows a schematized sectional view of a first apparatus according to the invention, wherein a hand with a pointing finger is shown to indicate that the protective layer of the apparatus cannot be reached with the finger;

FIG. 3A shows a schematized perspective view of a further embodiment of a container while being filled up with liquid;

FIG. 3B-3C shows a strongly schematized perspective view of the container of FIG. 3A after filling and prior to the insertion of a protective layer and the connecting of a discharging device;

FIG. 3D shows a schematized sectional view of the container after the insertion of the protective layer and the connecting of the discharging device;

FIG. 3E shows a schematized sectional view of the container including the protective layer and discharging device in a reverse state ready for use;

FIG. 3F shows a schematized sectional view of an overall system with a (buffer-) tank and an apparatus that comprises the container including the protective layer and discharging device, wherein the apparatus is attached to the tank and liquid is running out of the container into the tank;

FIG. 4A shows a schematized sectional view of a further embodiment after filling it up with liquid and prior to the connecting of a discharging device including a membrane that serves as protective layer;

FIG. 4B shows a schematized sectional view of the container of FIG. 4A after having connected the discharging device including the membrane and the connecting of a coupling nut, which serves for fixing the discharging device including the membrane;

FIG. 4C shows a schematized sectional view of a further overall system with a (buffer-) tank and an apparatus which comprises the container including a membrane as protective layer and the discharging device, wherein the apparatus was mounted on a tank and where liquid is running out of the container into the tank;

FIG. 5 shows a schematized perspective view of a further apparatus comprising a container and a discharging device being provided with two protective layers;

FIG. 6 shows a schematized perspective view of a further apparatus comprising a container and a discharging device being provided with a protective layer and a protection against manipulation positioned below;

FIG. 7A shows a schematized perspective view of a further container being provided with a tube which is positioned inside at least partially;

FIG. 7B shows a schematized perspective view of a further discharging device being provided with a membrane;

FIG. 7C shows a schematized perspective view of an apparatus comprising a container in accordance with FIG. 7A and a discharging device in accordance with FIG. 7B;

FIG. 8 shows a schematized view of a vehicle at the moment where a fuel is decanted from the apparatus into a (buffer-)tank;

FIG. 9 shows a schematized view of a vehicle with a series hybrid drive;

FIG. 10A shows a schematized view of an apparatus of the invention and of means in an open state, which serve for securing the apparatus in a vehicle;

FIG. 10B shows a schematized view of an apparatus according to FIG. 10A in a closed state;

FIG. 11 shows a perspective view of an apparatus comprising a container and a discharging device in accordance with the invention;

FIG. 12 shows a perspective view of an alternative container in accordance with the invention.

### DETAILED DESCRIPTION OF THE INVENTION

The word liquid 108 is herein used for all sorts of liquids. It concerns, for example, in particular liquids 108 which are combustible and/or chemically reactive. Of particular concerned are fuels, combustibles or heating materials, such as methanol.

The word container 21 is herein used for a container or bundle which is suitable for receiving a liquid 108, for storing it and, in case of need, for discharging it. Preferably, the container of all embodiments is produced from plastic. Very well suited is PET (polyethylene), PP (Polypropylene), HDPE (High Density Polyethylene), HM-HDPE (High-molecular-weight polyethylene), UHM-HDPE (Ultra-highmolecular-weight polyethylene) or a fluorelastomer, such as for example PTFE (Polytetrafluoroethylene), or a fluorthermoplast. Also suitable are plastics which are provided with a Fluorpoylmer coating (e.g. hydrophobic PTFE) or with an EVOH-coating (EVOH stands for Ethylene-Vinylalcohol-Copolymer).

The expression portable container 21 is herein used in order to refer to containers 21 having a weight and size so that it can be carried by a human being. The weight is preferably in the range between 5 and 25 kg. The size is preferably between a few centimenters and a maximum of 50 cm.

Exceptionally well suited are containers 21 which are produced by co-extrusion from one of the materials mentioned or from material combinations, or containers 21 which are (inside-)coated later by the application of one of said materials.

Exceptionally well suited are containers 21 or apparatus 20 which are produced by co-extrusion in the shape of a multilayer-extrudate (here preferably with a carrier layer of PET, PP, HDPE, HM-HDPE, UHM-HDPE and an inner layer of PTFE or EVOH). Formed components are produced by co-extrusion from which by means of further process steps the container 21 or the apparatus 20 are being produced.

Exceptionally well suited are containers 21 or apparatus 20 which are produced from preforms by means of a stretch-blowing or a blow-forming method. The preforms are preferably extruded or produced by means of a injection molding process. The injection molding process and the stretch-blowing or a blow-forming method can also be combined from a process-technological view in order to produce the containers 21 or apparatus 20.

Exceptionally well suited are containers 21 having an omniphobic or nano-coated (inner) surface. An omniphobic and a nano-coated surface have outstanding characteristics and repels fuel (e.g. methanol) reliably. Such an apparatus 20 does not have to be cleaned or only has to be cleaned rarely.

Euro-Plastic canisters, which are provided in accordance with the invention, can be used as containers 21 for all embodiments.

Plastic bottles (e.g. square or cylindrical), which are provided in accordance with the invention, can be used as containers 21 for all embodiments.

Preferably, the container 21 satisfies one or more of the following criteria:
translucent,
stackable,
resistant against chemicals,
resistant against mineral oils,
resistant against methanol,
sealed to prevent odors,
explosion protected,
protected against overpressure,
non-aging,
recyclable,
easy to be cleaned,
can be marked.

Preferably, the container 21 has a round, oval, polygonal or rectangular horizontal cross-section and a round, oval, rectangular or funnel shape in a vertical cross-section.

The words discharging device 30 are herein used for a hollow, preferably cylinder-shaped (pipe or hose-)body which is connectable with the container 21. Preferably, the discharging device 30 of all embodiments has the shape of a pipe or hose.

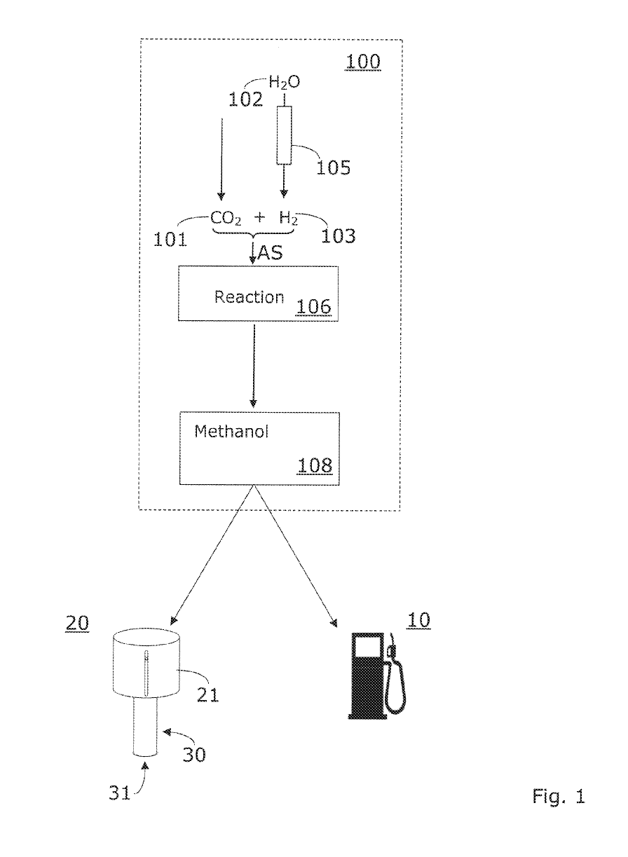

FIG. 1 shows a diagrammatic plan which discloses the basics steps of a method for producing methanol (as liquid 108). In connection with a water-electrolysis 105, water 102 can be transformed into hydrogen 103 and oxygen (not shown). In addition, carbon dioxide 101 is fed in. The combination of hydrogen 103 and carbon dioxide 101 with a suitable molar ratio undergoes a reaction 106 (preferably a catalytic reaction). Methanol as liquid 108 is thereby produced. This liquid 108 can be filled into an apparatus 20, as is going to be described in the following, instead of being supplied via a gasoline pump 10.

The process described can for instance be carried out in a Silicon-Fire facility 100, as for example described in the initially mentioned international Patent application with the Publication number WO2010069622A1.

The methanol 108 is thus filled into a tank cartridge 20 instead being provided at a gasoline pump 10 for fueling. The tank cartridge 20 can be carried in a vehicle without difficulty in order to put it to use if needed, or the liquid 108 can be decanted at a petrol station or at another sales point right from the tank cartridge 20 into the tank 60 of the vehicle. The hose-free fueling takes place quickly and cleanly.

For the safe handling of the container 21 and for a hose-free fueling, a suitable mechanical protection is required. In the following, different examples are described which a very safe and robust.

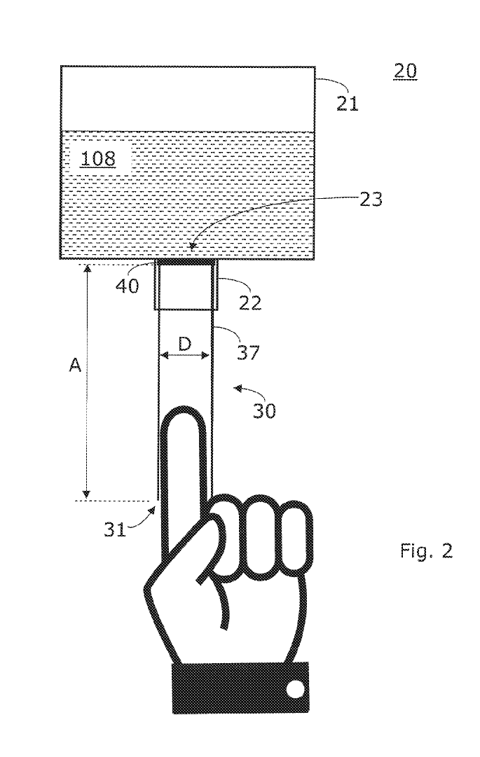

FIG. 2 shows a schematized sectional view of a tank cartridge 20 according to the invention, wherein a hand with a pointing finger is shown in order to indicate that the inside tank cartridge offset protective layer 40 of the tank cartridge cannot be reached with the finger. The apparatus 20 of all embodiments is designed for receiving, storing, carrying and discharging a liquid 108. For this purpose, it comprises a container 21. The container 21 in FIG. 2 is filled by about two-thirds with the liquid 108. The container 21 furthermore comprises a discharging device 30 being designed for discharging the liquid 108. The discharging device 30 preferably has a hollow cylinder shape and it is connected at a first side close to the container 21. The discharging device 30 comprises a discharge opening 31 at a second side. A protective layer 40 is provided in an area of the first side close to the container, which in a sound state prevents the liquid 108 from exiting from the container 21 into the discharging device 30. In addition, the protective layer 40 serves as odor protection and as barrier against contamination. The protective layer 40 is relatively thick in the figures in order to make it more visible. The protective layer 40 is positioned with an offset with a minimum distance In addition, or alternatively, the discharge opening 31 can have an inner diameter D preventing an intrusion with the finger.

Embodiments of the invention preferably have a double protection. On one hand, embodiments have the protective layer 40 to prevent a running out of the liquid 108. On the other hand, the protective layer 40 is set back so that it cannot be reached or manipulated with a finger. The minimum distance A is at least 6 cm for this purpose and/or the inner diameter D has a maximum of 1 cm. The offsetting is herein also called manipulation protection.

Preferably, embodiments comprise an inside or outside lying tube 22 at the container 21. The embodiment which is shown in FIG. 2 has an outside lying tube 22, the length of which corresponds to about one-quarter of the distance A. The length of the tube 22 can also be chosen to be different.

The tube 22 can be completely outside the container 21, it can reach partially into the inside of the container 21 or it can be completely inside. Depending on the arrangement of the tube 22, the discharge opening 23 for discharging the liquid 108 has to be carried out and/or positioned differently. Preferably, the discharge opening 23 is always at the deepest point of the container 21 in order to facilitate a discharging due to the gravitational force.

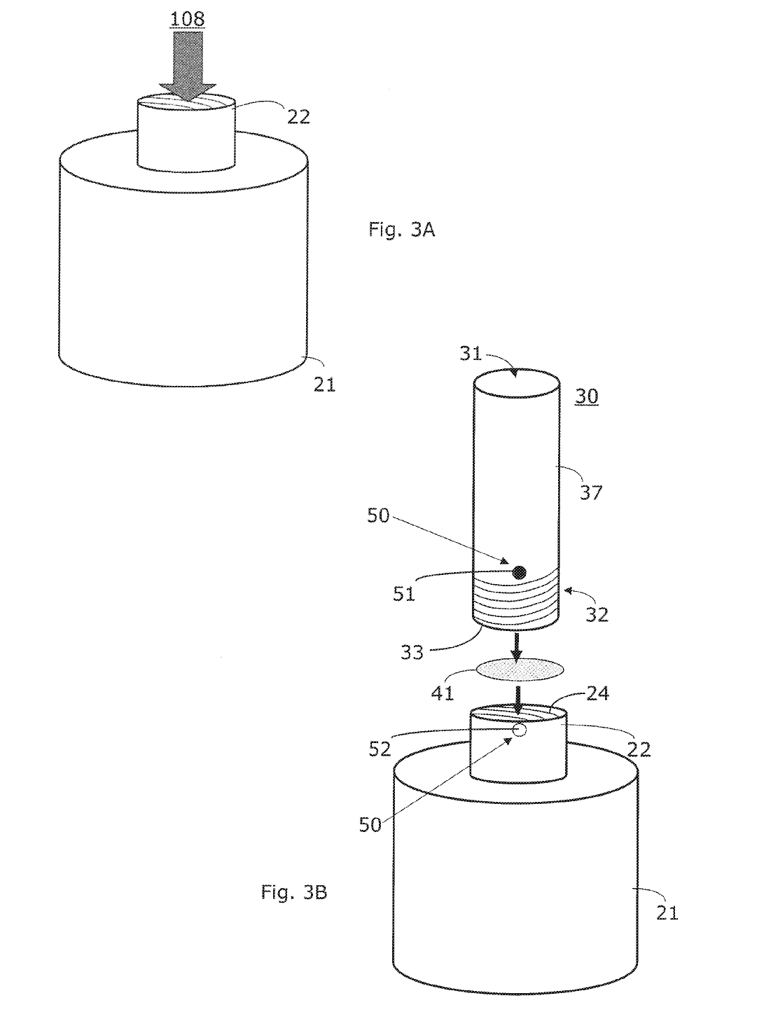

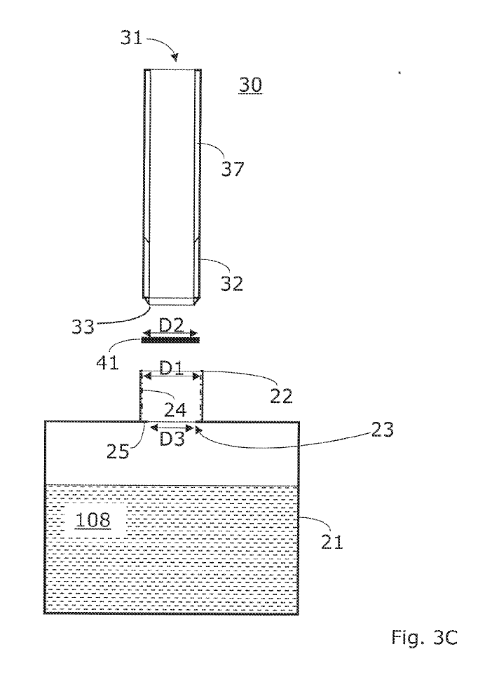

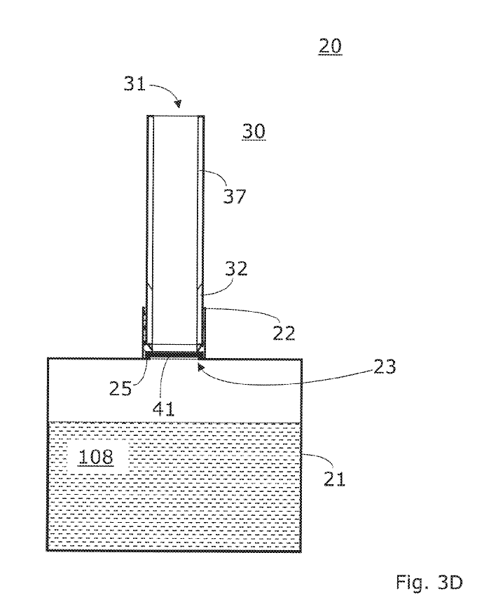

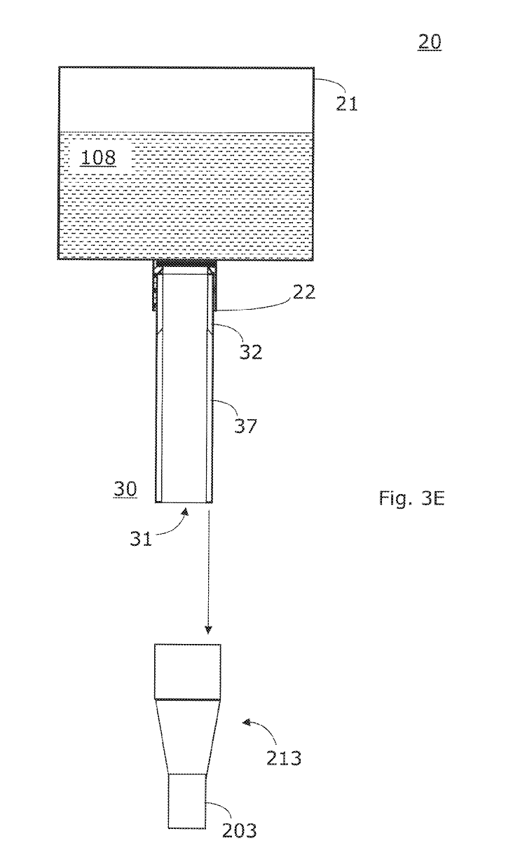

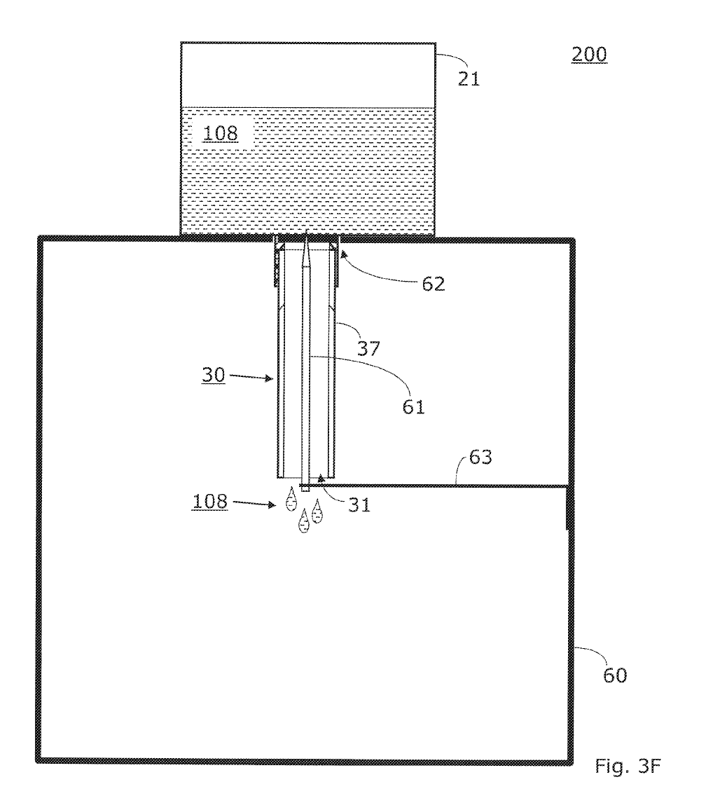

The protective layer 40 is designed so that it can be mechanically pierced, cut through or destroyed. For this purpose, a mechanical counterpiece 61 is provided at the tank 60 (see, FIG. 3F) or at another receiving means at the vehicle side, which mechanically pierces, cuts through or destroys the protective layer 40 when attaching or putting on the apparatus 20.

The mechanical counterpiece 61 (FIG. 3F) can be positioned stationary or it can be positioned moveably (deliverably).

FIG. 3A shows details of a further embodiment. The apparatus 20 can be turned around in order to be filled up with the liquid 108 through the tube 22. The filling with liquid 108 is depicted in FIG. 3A by an arrow pointing downwards.

In FIG. 3B a schematized perspective view of the container 21 of FIG. 3A after the filling up and prior to the insertion of a protective layer 40 and the connecting of a discharging device 30 is shown. FIG. 3C shows a corresponding, strongly schematized sectional view.

Steps are shown in FIGS. 3B and 3C that may follow after the filling up. After the filling up, a protective layer 40, here having the shape of a separate circular foil 41, can be inserted into the tube 22. The foil 41 has an outer diameter D2 which is slightly smaller than the inner diameter D1 of the tube 22. There is a ring shoulder 25 in a transitional area between the tube 22 and the container 21 in the example shown. The ring shoulder 25 has an inner diameter D3 being smaller than the outer diameter D2 of the foil 41.

Preferably, a single layer or multi-layer foil 41 is employed.

Preferably, a plastic foil 41 is employed.

Preferably, foil 41 is employed having a deformation behavior (i.e. the elasticity of which) and physical bursting characteristics (i.e. the failure characteristics of which) given so that the foil 41 can be destroyed by the mechanic counteraction with the mechanical counterpiece 61 and that the remaider of the foil 41 retract/shorten. In case of a homogeneous planar pressure, it should not be possible for the foil 41 to be destroyed, whereas it should burst at a punctual load by action of the counterpiece 61.

The discharging device 30 can now be connected to the tube 22. The discharging device 30 here has got an outside thread 32 and the tube 22 a complementary internal thread 24. The connection is provided by screwing the discharging device 30 into the tube 22.

In the assembled state, which is schematically depicted in FIG. 3D, the foil 41 is lying on the ring shoulder 25 and it seals in its sound state the discharge opening 23. The foil 41 is held in position by the ring-shaped lower ridge 33 (see FIGS. 3B and 3C) of the discharging device 30 and is pressed against the ring shoulder 25. If the whole apparatus 20 is now turned around, as shown in FIG. 3E, no liquid 108 can run out.

FIG. 3F shows a first overall system 200 with (buffer-)tank 60 and apparatus 20, wherein the apparatus 20 comprises a container 21 including protective layer 40 (here a foil 41) and discharging device 30. An overhead opening 62 is provided at the tank 60, which enables an insertion of the discharging device 30 into the inside of the tank 60. There is a mechanical counterpiece 61 (here in the shape of a needle) which, when inserting the discharging device 30 with the protective layer 40, here provided as a foil 41, enters into a mechanical interaction to pierce the foil 41. The state right after the piercing is shown in FIG. 3F. The droplets underneath the discharging device 30 indicate that the liquid 108 due to the gravitational force is running through the inner side of the discharging device 30 into the tank 60. The mechanical counterpiece 61 can be statically connected to the fastening means 63 in the tank 60, as schematically depicted in FIG. 3F.

Means are preferably provided for all embodiments in order to allow air to stream in so that no pressure builds up in the container 21 which prevents or slows down the running out of the liquid 108.

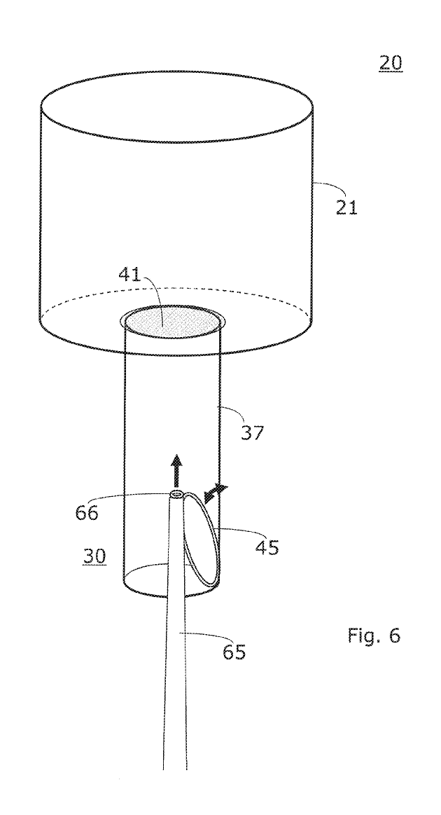

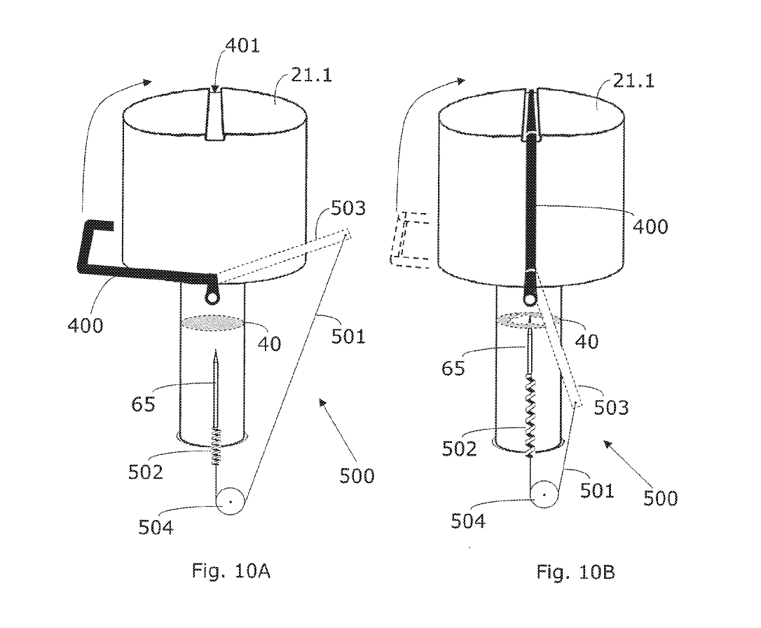

Depending on the embodiment, the mechanical counterpiece 61 can be designed as needle (as shown in FIG. 3F and as indicated in FIG. 10A, 10B), as hollow needle (as indicated in FIG. 6) or as hollow cylinder with a sharp-edged upper edge.

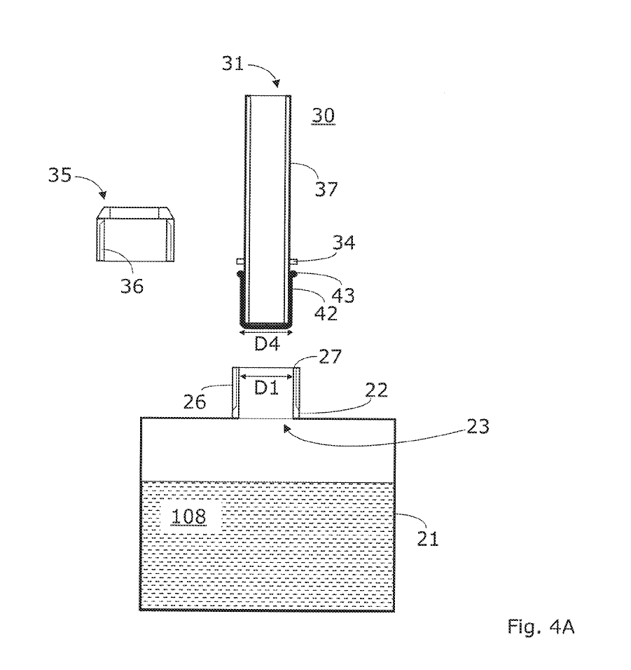

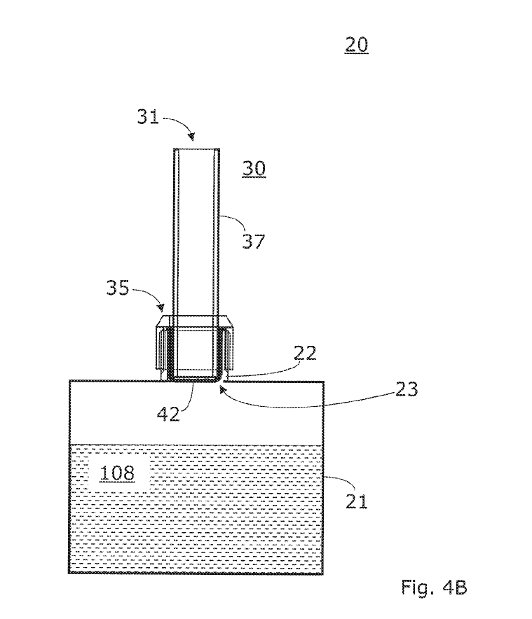

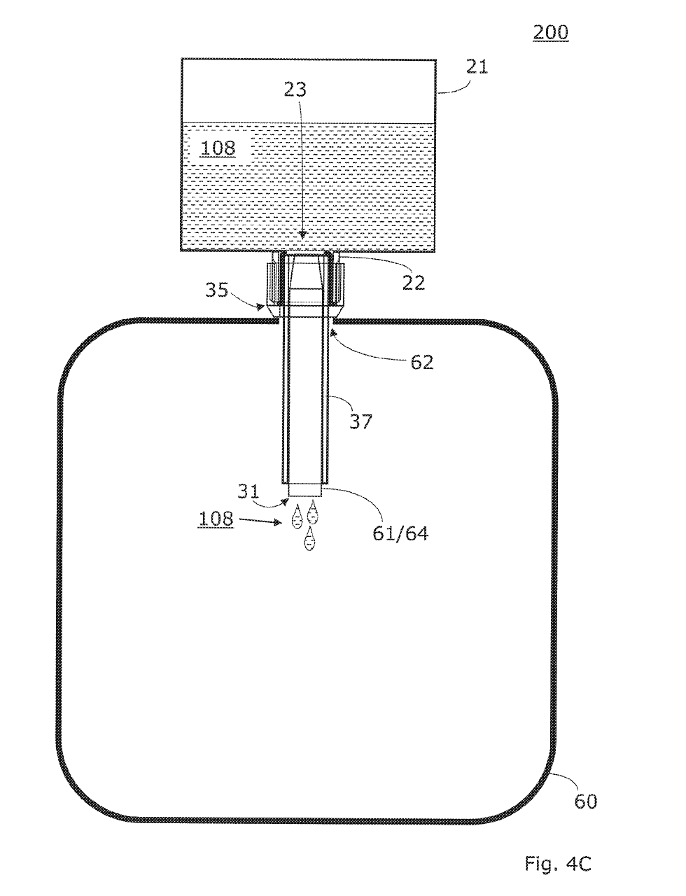

A further embodiment of the invention is shown in the FIGS. 4A, 4B, and 4C. FIG. 4A shows the situation after filling up with liquid 108 and prior to attaching the discharging device 30 including membrane 42, which serves as a protective layer. Here an elastic membrane 42 is employed which is being pulled over or sheathed over the lower most area of the discharging device 30, as can be seen in FIG. 4A. The elastic membrane 42 is intentionally shown to be thick in the figures in order to make it clearly visible. The thickness of the membrane 42 in reality is smaller. The discharging device 30 here includes a collar 34 lying outside, which is schematically depicted in FIG. 4A, and a coupling nut 35. The coupling nut 35 has an internal thread 36 being complementary with respect to an outside thread 26 of the tube 22.

Preferably, a membrane 42 is produced from a thin, non-tear-resistant plastic which can be destroyed by mechanical interaction with the counterpiece 61.

Preferably, a membrane 42 is employed having a deformation behavior (e.g. the elasticity of which) and physical burst characteristics (e.g. the failure characteristics of which) are defined so that the membrane 42 is destroyed due to the mechanical interaction with the counterpiece 61 and that the remainders of the membrane 42 retract/contract. In case of a homogeneous planar pressure the membrane 42 should be stretchable, whereas it should burst at a punctual load by action of the counterpiece 61.

Preferably, a membrane 42 is employed which is made from vulcanized rubber.

Preferably, a membrane 42 is employed which is made from Polyethylene (PE), Polyurethane (PUR) or Polyisoprene.

FIG. 4B shows the container 21 after attachment of the discharging device 30 including the membrane 42 and the attachment of the coupling nut 35 which serves to fix the discharging device 30 including membrane 42. The discharging device 30 including membrane 42 is pushed into the inner side of the tube 22. Then the coupling nut 35 screwed onto the thread 26 of the tube 22. The coupling nut 35 is lying at the collar 34 and pulls, while screwing the coupling nut 35, the discharging device 30 including membrane 42 into the inner side of the tube 22.

The elastic membrane 42 may optionally comprise a circumferential ridge 43, as can be well seen in FIG. 4A. This ridge 43 on the one hand provides stiffness and on the other hand serves as seal which in the mounted state is lying between the upper, ring-shaped edge 27 of the tube 22 and the collar 34. When screwing tight the coupling nut 35, the ridge 43 is compressed and thus serves as seal.

The mechanical counterpiece 61 can be designed as needle (as shown in FIG. 3E, for example), or as hollow needle 65 (as indicated in FIG. 6) or for instance as hollow cylinder with a sharp-edged upper edge, in order to destroy the elastic membrane 42 when inserting the discharging device 30 into an opening 62 of a tank 60. The membrane 42 bursts because of the elasticity when it enters into contact with the counterpiece 61 and thus opens up the passage between the container 21 and the discharging device 30. Similar to FIG. 3F, the liquid can exit and run into the tank 60.

In situations where no intermediate tank 60 is employed, the apparatus 20 can be directly or indirectly coupled to a fuel pipe 203, for example, as indicated in FIG. 3E. The connection can be done by means of a transition element 213. The transition element 213 may comprise an optional fuel pump and/or a fuel filter.

A second overall system 200 with tank 60 and apparatus 20 is shown in FIG. 4C, wherein the apparatus 20 comprises a container 21 including protective layer 40 (here a membrane 42) and discharging device 30. An overhead opening 62 is provided at the tank 60 which enables the insertion of the discharging device 30 into the inner side of the tank 60. There is a mechanical counterpiece 61 seated in the area of the overhead opening 62 (here having the shape of a hollow cylinder 64), which, when inserting the discharging device 30 enters into a mechanical interaction with the protective layer 40, here in the form of a membrane 42, to pierce the membrane 42. In the example illustrated, a hollow cylinder 64 with sharp-edged upper edge is employed as mechanical counterpiece 61. The hollow cylinder 64 has an outer diameter being exactly adapted to the inner diameter of the discharging device 30 and the diameter of the discharge opening 23 of the container 21. The state right after the piercing is shown in schematic form in FIG. 4C. The droplets underneath the discharge opening 31 indicate that the liquid 108 runs through the inner side of the mechanical counterpiece 61 into the tank 60.

The hollow cylinder 64 can be connected with fastening means in the tank 60, which are not shown in FIG. 4C. The hollow cylinder 64 can also be mounted moveably (for instance like the needle in FIG. 10A, 10B).

In the following sections and the corresponding figures details of further embodiments are described. These details can be applied to the respective other embodiments and can be combined with other means of the invention described.

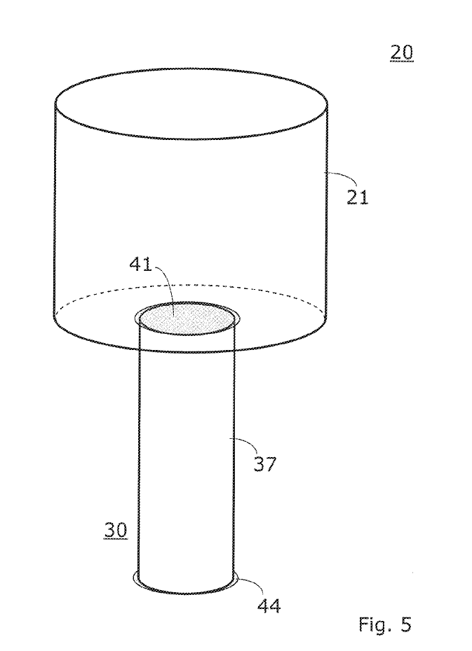

FIG. 5 shows a schematized perspective view of a further container 21 with discharging device 30 being provided with two protective layers (here having the shape of two circular foils 41, 44). The first foil 41 sits, as described, in the area of transition from the discharging device 30 into the container 21. The second foil 44 (also called lower foil) sits in the area of the discharge opening 31 of the discharging device 30. The second foil 44 serves as so-called protective means. The foils 41 and/or 44 can be glued on, vulcanized on, clamped or can be screwed on e.g. by employing a thread and (coupling)nut. A solution in accordance with FIG. 5 offers a double protection against unwanted discharge or against manipulation.

FIG. 6 shows a schematized perspective view of a further container 21 with a discharging device 30 being provided with a protective layer 40 (here having the shape of a circular foil 41) and a (mechanical) manipulation protection 45 at the bottom. The manipulation protection 45 serves as additional protection means. In the example shown, a hollow needle 65 is employed as mechanical counterpiece 61. The hollow needle 65 in turn sits in a tank 60 or a vehicle 201, which is not shown. When inserting the discharging device 30 into the opening 62 of the tank 60 or vehicle 201, the hollow needle 65 presses the manipulation protection 45 aside. Then, when inserting the discharging device 30 deeper into the opening 62, the ring-shaped upper edge 66 of the hollow needle 65 pierces the foil 41 and thus opens the passage 23 from the container 21 to the inner part of the discharging device 30.

Preferably, the manipulation protection 45 is provided for many embodiments. It can be designed so that only a hollow needle 65 or another mechanical counterpiece 61 allows or enables the opening of the manipulation protection 45.

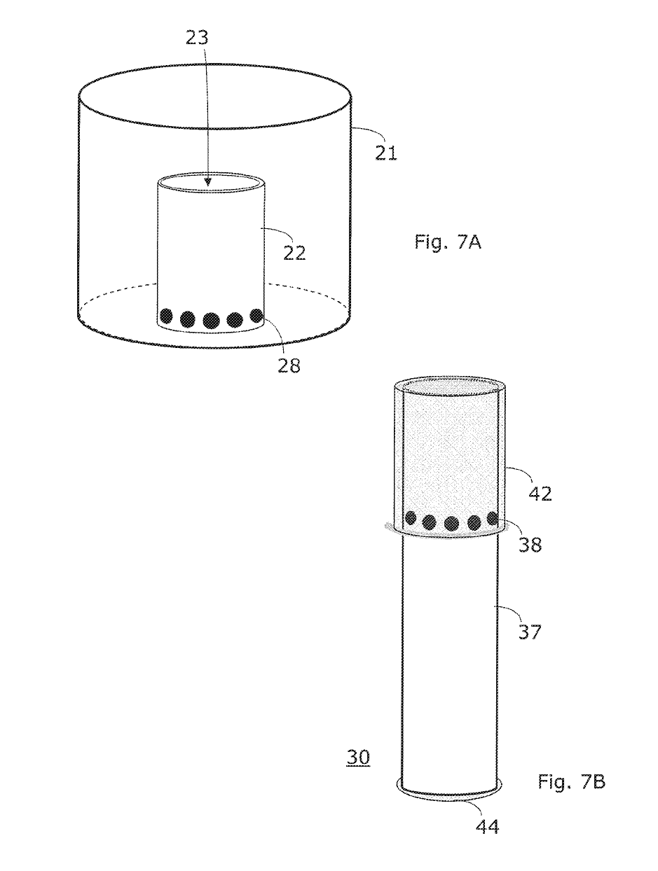

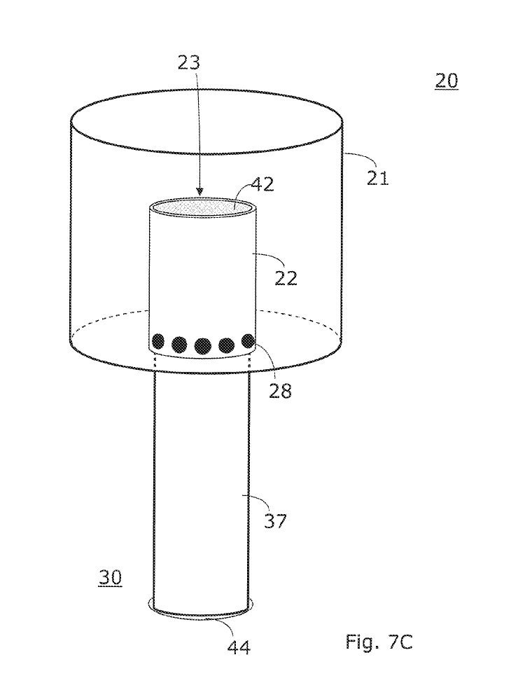

FIG. 7A shows a schematized perspective view of a further container 21 being provided with a tube 22 which is positioned at least partially inside. There are passages 28 (here with circular shape) provided at the tube 22 which are lying at the deepest point of the container 21 in order to let all of the liquid 108 run out due to the gravitational force. Here the tube 22 comprises an upper discharge opening 23. This discharge opening 23 is optional.

FIG. 7B shows a schematized perspective view of a discharging device 30 being provided with an elastic membrane 42. The membrane 42 can have the shape of a topcoat, as described already in connection with FIG. 4A. Passages 38 are also provided at the discharging device 30 (here with circular shape), which are designed and positioned so that they essentially overlap with the passages 28 at the tube 22, if the discharging device 30 is plugged into the tube 22, as shown in FIG. 7C. Optionally, a lower foil 44 can be provided, as described already, in order to provide an additional manipulation protection.

FIG. 7C shows a schematized perspective view of a corresponding apparatus 20 comprising a container 21 in accordance with FIG. 7A and a discharging device 30 in accordance with FIG. 7B. If now a mechanical counterpiece 61 (not shown in FIG. 7C) is employed, then the membrane 42 is destroyed. The destroyed membrane 42 opens up the passages 28 and 38 so that liquid 108 can run out of the container 21 through the passages 28 and 38 into the discharging device 30 and a tank 60 or directly into a fuel pipe 203. If, in addition a discharge opening 23 is provided, the destroyed membrane 42 opens up this discharge opening 23, too. Then liquid 108 can run out of the container 21 through the discharge opening 23 into the discharging device 30 and a tank 60.

An embodiment with passages 28 and 38 and with discharge opening 23 has the advantage that air can stream in without problem and that thus no under pressure builds up which prevents or slows down the discharging.

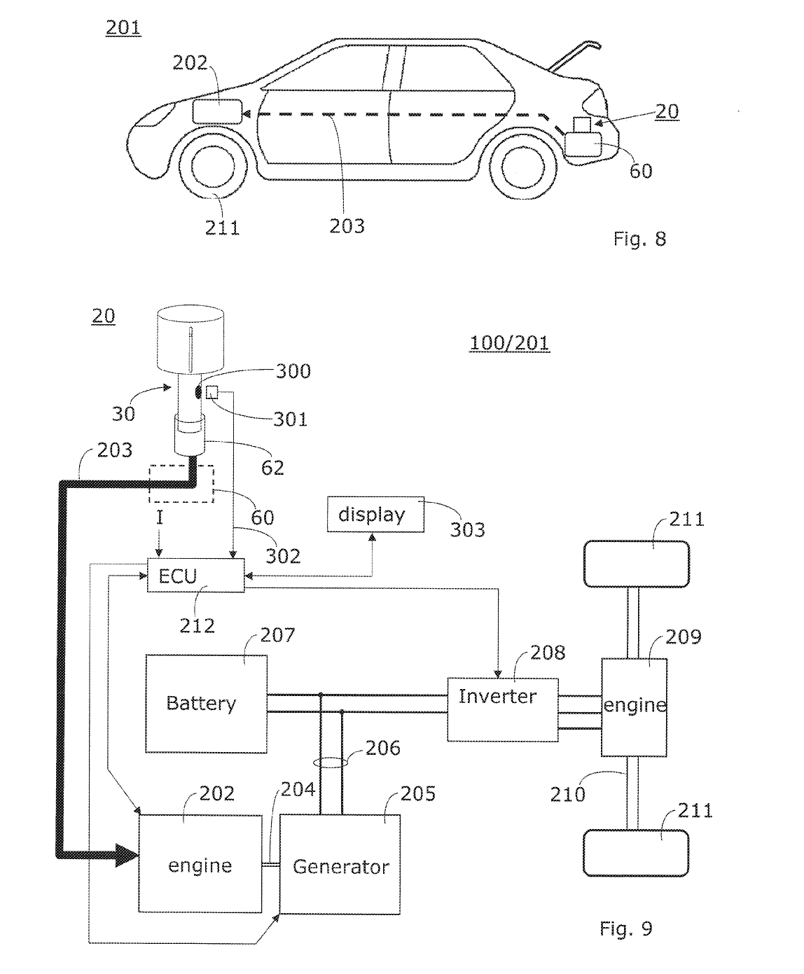

FIG. 8 shows a schematized view of a vehicle 201 at the moment where a fuel 108 is decanted from an apparatus 20 into a tank 60 at the vehicle. The vehicle 201 may be an electric vehicle 201 which is equipped with an engine 202 serving as range-extender. This engine 202 is, as schematically depicted in FIG. 8, supplied via a fuel pipe 203 with fuel 108, which is taken from the tank 60.

Said range extender is designed to produce electric current on-board of the vehicle 201. This electric current can be stored in a battery 207 (FIG. 9), accumulator or super-cap, or it can be provided to the at least one electric engine 209. In accordance with the invention, the range extender is being supplied with methanol 108 as liquid fuel either right from the container 20 or via an optional (buffer)tank 60. The fuel-powered engine 202 combusts the methanol 108 and it preferably operated with an optimum revolution where the consumption of methanol 108 is low relative to the electric power generated by the generator 205 coupled to the engine 202.

In accordance with the invention, the fueling of the tank 60 takes place without pressure and without the employment of pumps or the like. Due to the gravitational force, the fuel 108 runs from the container 21 of the apparatus 20 into the tank 60 as soon as the protective layer 40 has been opened. The apparatus 20 of all embodiments is thus designed for gravitation-fueling. The gravitation-fueling of all embodiments is done without electricity, since no pumps have to be driven. The fueling can be done anytime and at any place without requiring a power connection or even some other form of infrastructure.

The apparatus 20 is safe and thus can be distributed via retail businesses or even via direct mail selling. In particular if methanol is employed as fuel 108, this approach is particularly advantageous since methanol is difficult to inflame. Furthermore, methanol can be decomposed biologically if it should end up in water.

The described embodiments prevent or at least make mis-manipulations so difficult that a laymen does not get into contact with the liquid 108 unconsciously or ignorantly.

Preferably, securing means 50 are included to prevent a loosening and/or removing and/or an unconscious manipulation of the discharging device 30. The securing means 50, however, are optional.

An example of a securing means 50 is shown in FIG. 3B, which comprises a latching element 51 (e.g. a spring-mounted sphere) and a complementary receiving opening 52. By latching the latching element 51 in the receiving opening 52 a turning or unscrewing of the discharging device 30 is prevented. Preferably, the latching element 51 is designed so that is cannot be manually actuated by only with a (special-)tool.

Preferably, a package band (made from plastic or paper) may serve as securing means 50 and which is for this purpose glued around the tube 22 and a part of the discharging device 30. This package band seals the tube 22 optically recognizable with the discharging device 30 and secures both with respect to each other.

Preferably, a splint, a rivet or a bolt may serve as securing means 50.

All embodiments of the invention can also be employed in order to receive, store, carry and discharge alcohol in order to use this alcohol for increasing the efficiency and power of a combustion engine. Details for this can be derived from the initially mentioned European patent application with the application number EP 1155310.3.

The apparatus 20 should preferably be designed as a passive apparatus 20 without sensor(s) and/or fuel pumps. When using the apparatus 20 in a vehicle 201, it is however important to “know” at any time how much fuel 108 is still left in the apparatus 20. It is indicated in FIG. 1 that the apparatus 20 may be provided with an optical filling level indication. This optical filling level indication can at any time be read if needed. However, in an automated overall system 100 a precise determination of the filling level is required. Since it is not desired to have a sensor inside the containers 21, a solution is preferred where means 300 are attached to the apparatus 20 which can be sampled, as indicated in FIG. 9. At least one sensor 301 is provided in the area of the receiving opening 62 in order to be able to recognize a characteristic feature of the apparatus 20 during or after the insertion of the apparatus 20 into the receiving opening 62 and to hand it over to the (engine-)control 212. Using this approach for instance on the side of the vehicle it is possible to distinguish a 10 liters comprising apparatus 20 from a 20 liters comprising apparatus 20. If the apparatus 20 serves as supply of a range extender 202 with fuel 108, the actual consumption can be determined fairly easily and very precisely, since the range extender 202 is operated with a relatively exactly defined revolution and load. On the vehicle side, it can thus be determined relatively exactly by the control 212 how much fuel 108 from a 10 liters comprising apparatus 20 has been consumed and how much remaining fuel 108 thus is still available. A corresponding solution is for example known from U.S. Pat. No. 7,259,664.

FIG. 9 shows a strongly schematized view of the components of a vehicle 201 with a series hybrid drive. The drive comprises a combustion engine 202 being employed as range extender and which for this purpose for example drives a generator 205 via a shaft 204. The generator 205 generates current that can be guided via conductors 206 into a battery 207 (or an accumulator or a super-capacitor) or via an inverter 208 (transformer) to one (or more) electric engines 209 of the vehicle 201. The electric engines 209 can for instance drive an axle 210 of the wheels 211. Particularly preferred, however, are embodiments with wheel-hub attached engines or with wheel-side engines, wherein at least two of the wheels 211 are each equipped with one such engine.

The vehicle 201 comprises a bay or port which is designed so that at least a part of the discharging device 30 can be inserted into a receiving opening of the vehicle 201. The receiving opening is connected to the fuel pipe 203 and/or to the (buffer)tank 60. In FIG. 9, the bay or port is symbolized by the overhead opening 62. The actual shape of the bay or port depends on the size and shape of the container 21 and/or its discharging device 30.

The bay or port can be inside the car (e.g. close to the engine 202) or it can be acessible from outside the vehicle 201.

Details of a suitable constellation of wheel-side engines can be derived from the published patent application EP2199137A1 of the company Klingelnberg AG.

If the generator 205 is an alternating current generator, a rectifier (not shown) is employed. The inverter 208 transforms the direct current of the battery 207 or of the generator 205 into an alternating current in a form which is suitable for the engine/s 209. The engine control 212 (called engine control unit or ECU) monitors these procedures. The inverter 208 comprises circuit elements which are controlled and acted upon by the ECU 212. The ECU 212 is provided with input values I (signals) from the different components of the vehicle 201. The ECU 212 makes decisions based on these input values I and it outputs control values to the engine 202, the generator 205 and the inverter 208.

One sensor 301 is preferably present at least in the area of the receiving opening 62 (e.g. in the area of the hollow cylinder 37) in order to recognize a characteristic feature (e.g. the filling amount) of the apparatus 20 when or after inserting the apparatus 20 into the receiving opening 62 and to be able to hand it over to the control 212. For this purpose there is a signal connection 302 to the ECU 212.

Particularly preferred are embodiments where a mechanical feature serves as sampling means 300. Thus the hollow cylinder 37 might be provided with a drill hole, trench or nose which can be detected by the sensor 301. There could also be a small magnetic plate serving as means 300 that can be sampled and the sensor 301 can detect the position of the magnetic plate. The volume of the containers 21 might be coded via the position of the magnetic plate. By means of this, at the side of the vehicle a 10 liters comprising apparatus 20 can be distinguished from a 20 liters comprising apparatus 20.

The tank 60 is not mandatory. It is thus shown by dashed lines in FIG. 9.

A connection via a fuel pipe 203 to the engine 202 is established when inserting the apparatus 20 into an overall system 100 or vehicle 201. In FIG. 8 as well as FIG. 9, the fuel pipe 203 is depicted in schematic form. Preferably, a fuel pump (not shown) is employed in order to supply the engine 202 with fuel 108 evenly and with sufficient pressure. The fuel pump is also controllable and can be regulated by the ECU 212.

The vehicle 201 might include a fuel display 303 in order to always display the determined or the calculated remaining fuel 108 in the container 21.

In order to secure the apparatus 20 in a vehicle 201, a bracket 400 might be used, a schematically presented in FIGS. 10A and 10B. The apparatus 20 might be provided with a receiving section 401 for a bar or flank of the bracket 400. A receiving section 401 is shown in the figures on the upper side 21.1 of the container 21. The upper side 21.1 can be designed slightly arched or oblique in order to exert a fixing pressure which presses the apparatus 20 downwards, e.g. into the opening 62.

Preferably, the bracket 400 is a spring bracket or a spring-mounted bracket so that it sits in the receiving section 401. The bracket 400 is swivel mounted in the vehicle 201 (e.g. at the optional tank 60 or at another part of the vehicle). The swivel mounting is not shown in the FIGS. 10A to 10B.

In FIG. 10A the bracket 400 is shown in an open state. After having inserted the apparatus 20 into the opening 62 at the vehicle side, the bracket 400 can be manually brought from the 9 o'clock position into a 12 o'clock position. In doing so, a small force is to be applied in order to let the bar or flank of the bracket 400 latch into the receiving section 401. The closed position is shown in FIG. 10B.

It is optional to actuate a mechanical counterpiece 61 or needle 65 by means of an action mechanism 500 in order to pierce the protective layer 40 (e.g. provided as foil 41 or membrane 42). The piercing moment is shown in FIG. 10B. After the piercing liquid 108 (fuel) can exit from the container 21 and can go into the fuel pipe 203 of the vehicle 201 directly or indirectly.

In the FIGS. 10A and 10B, the action mechanism 500 is intentionally shown in schematic form in order to be able to describe the function. There are many possibilities to realize such an action mechanism 500 in a small and robust form. Lever arms, actuating elements, pulling elements and springs can be employed to effect the piercing.

A short string 501 pulls down a needle 65 in FIG. 10A. One end of the string 501 is connected to a lever 503. Its second end is connected with a needle 65 or spring 502. In the position of FIG. 10A the needle 65 is in a lower position and the pressure spring 502 is pressed together. If the bracket 400 is now moved into the position of FIG. 10B, the lever 503 moves downwards in clockwise direction and the tension, which acts on the string 501, decreases. The pressure spring 502 expands and moves the needles 65 upwards so that the tip of the needle 65 can pierce the protective layer 40. In the example shown, the string 501 is guided around a reel 504.

The principle just described, can also be applied to a hollow needle or to a counterpiece 61.

Preferably, the discharging device 30 has a length between 6 and 10 cm. A part of the length of the discharging device 30 can sit inside the container 21. In this case, preferably only a length of 2-5 cm protrudes out of the container 21 and a discharging device according to the invention.

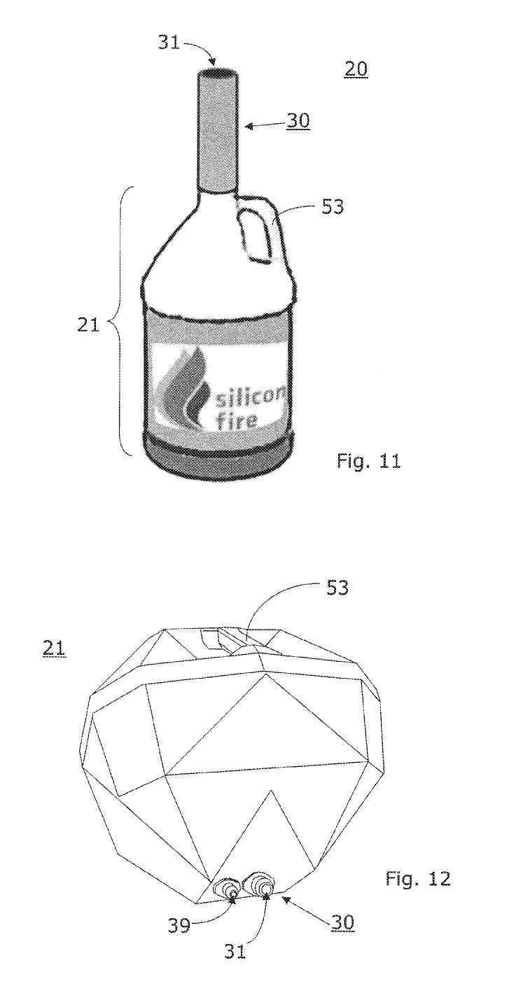

Preferably, the apparatus 20 include handle for easy carrying and handling. FIG. 11 shows a perspective view of an apparatus 20 comprising a container 21. A handle 53 is provided at the apparatus 20.

FIG. 12 shows a perspective view of another container 21 of the invention which has a polygonal shape. A handle 53 is provided for easier handling of the container 21. Means are provided preferably in order to allow air to stream in so that no under pressure builds up in the container 21 which prevents or slows down the running out of the liquid 108. The container 21 of FIG. 12 comprises a separate opening serving as air inlet 39.

The vehicle or port of said vehicle 201 preferably includes a receiving bay or port for inserting the container 21. It is obvious that the shape and size of the receiving bay or port matches the shape and size of the container 21 to be used.

In preferred embodiments, the receiving bay or port comprises an opening for receiving the discharging device 30. If the discharging device 30 has the shape of a connecting tube or piece, as illustrated in FIG. 12, the opening is designed so as to provide for a liquid-tight connection between the discharging device 30 and a fuel pipe 203 or an overhead opening 62.

Preferably, the connection between the discharging device 30 and the opening is self-sealing when a protruding end of the discharging device 30 is plugged into the opening. It is, however, also possible to provide a sealing element which manually or automatically activated in order to establish a liquid-tight connection when or after the discharging device 30 is plugged into the opening.

In preferred embodiments, the receiving bay or port furthermore comprises an opening for allowing air to stream through the air inlet 39 into the container 21 while the liquid fuel 108 is running through the discharging device 30 into the fuel pipe 203.

In preferred embodiments, the receiving bay or port furthermore comprises at least one sensor in order to be able to recognize a characteristic feature of the container 21 while or after inserting it into the vehicle or while or after mounting the container inside the vehicle. This feature is used in order to hand over information related to the respective characteristic feature to a control (e.g. the ECU 212) of the vehicle 201.

In order to avoid sparks, solutions are preferred which are non-electrical. Very good and reliable results can be achied using mechanical and/or magnetic and/or optical solutions.

In case of a mechanical solution, a 3-dimensional feature is provided at or on the container 21 which can be detected by a mechanical sensor (e.g. a lever switch). If, for instance, a nose at the container 21 is inserted into a slot of the receiving bay or port, a spring loaded lever is activated. The movement of this lever then open or close a switch. Instead of a mechanical switch, a light barrier might be used. This light barrier is for instance interrupted if the container 21 with a specific mechanical feature is present.

A metal element (e.g. a metal inlay) can be attached to the container 21. If this metal element comes close to a magnet, a switch can be triggered.

If different sizes of containers 21 are to be distinguished, a coding scheme can be used in connection with the above-described sensing solutions.

If more information is to be conveyed (e.g. the capacity of the container 21 and/or a filling date), an optical solution is preferred where a light sensitive element (e.g. a CCD chip) is used to read a code (e.g. a bar code or QR-code).

The invention can also be used in connection with boats and other vehicles. The invention can also be used in small appliances which comprise a combustion engine or a fuel cell.

### REFERENCE NUMBERS

| | |
|---|---|
| Petrol station | 10 |
| Apparatus (tank cartridge) | 20 |
| Container | 21 |
| Upper side | 21.1 |
| Tube | 22 |
| Discharge opening | 23 |
| internal thread | 24 |
| Ring shoulder | 25 |
| outside thread | 26 |
| upper ringshaped ridge | 27 |
| Passages | 28 |
| Filling level indication | 29 |
| Discharging device | 30 |
| Discharge opening | 31 |
| outside thread | 32 |
| ringshaped lower ridge | 33 |
| Collar | 34 |
| Coupling nut | 35 |
| internal thread | 36 |
| Hollow cylinder | 37 |
| Passages | 38 |
| air inlet | 39 |
| Protective layer | 40 |
| foil | 41 |
| Membrane | 42 |
| ridge | 43 |
| Lower foil | 44 |
| Mechanical manipulation protection | 45 |
| Securing means | 50 |
| Latching element | 51 |
| Receiving opening | 52 |
| Handle | 53 |
| Tank | 60 |
| mechanical counterpiece | 61 |
| overhead opening | 62 |
| Fastening means | 63 |
| Hollow cylinder | 64 |
| (Hollow) needle | 65 |
| Silicon-Fire facility | 100 |
| Carbon dioxide | 101 |
| Water/H₂O | 102 |
| Hydrogen | 103 |
| Carrying out an electrolysis | 105 |
| Catalytic reaction | 106 |
| Methanol | 108 |
| Overall system | 200 |
| Vehicle | 201 |
| Engine (Range-Extender) | 202 |
| Fuel pipe | 203 |
| Shaft | 204 |
| Generator | 205 |
| Conducts | 206 |
| Battery/accumulator/super-cap | 207 |
| Inverter (converter) | 208 |
| E-Engine | 209 |
| Axle | 210 |
| Wheels | 211 |
| Engine control | 212 |
| Transitional element | 213 |
| sampling means | 300 |
| Sensor(s) | 301 |
| Signal connection | 302 |
| Fuel display | 303 |
| Bracket | 400 |
| Receiving section | 401 |
| Action mechanism | 500 |
| string | 501 |
| Pressure spring | 502 |
| Lever | 503 |
| Reel | 504 |
| Minimum distance | A |
| Inner diameter | D |
| Inner diameter | D1 |
| Outer diameter | D2 |
| Inner diameter | D3 |
| Input values | I |

What is claimed is:

1. A vehicle comprising:
an electric engine and a battery or accumulator for supplying said electric engine with electric power;
a fuel-powered engine being coupled to an electric generator so as to serve as range extender of said vehicle;
a portable container for receiving, storing, carrying and discharging a liquid fuel, said container comprising a discharging device being in fluid connection with said container when being engaged with a receiving bay or port of said vehicle, and having a discharge opening for discharging the liquid fuel for said fuel-powered engine, wherein said container comprises a mechanical protection against manipulation in order to ensure that the liquid fuel can only be discharged if the container is engaged with the receiving bay or port of said vehicle.

2. The vehicle of claim 1, wherein said container is a passive apparatus without attached sensor(s) and/or fuel pumps.

3. The vehicle of claim 1, wherein discharging of the liquid fuel is carried out by gravity.

4. The vehicle of claim 1, wherein the discharging of the liquid fuel is without electricity.

5. The vehicle of claim 1, the discharging of liquid fuel is done without a hose.

6. The vehicle of claim 1, wherein said receiving bay or port is designed so that at least a part of the discharging device can be inserted into an opening of said receiving bay or port.

7. The vehicle of claim 6, further comprising a (buffer-)tank being positioned in a fluid connection with said receiving opening and said fuel-powered engine.

8. The vehicle of claim 1, further comprising at least one sensor in order to recognize a characteristic feature of the container while or after inserting the container into the vehicle.

9. The vehicle of claim 8, further comprising a control unit being programmed to determine or calculate the vehicle's fuel consumption.

10. The vehicle of claim 1, wherein said mechanical protection comprises a protective layer in or at said discharging device.

11. The vehicle of claim 1, wherein said mechanical protection comprises a protective layer being positioned with an offset inside said discharging device of a minimum distance with respect to the discharge opening.

12. The vehicle of claim 11, wherein said offset is at least 6 cm.

13. The vehicle of claim 10, wherein foil or a membrane serves as protective layer.
